(19) United States
(12) Patent Application Publication
(10) Pub. No.: US 2012/0142488 A1
(43) Pub. Date: Jun. 7, 2012

(54) SYSTEM AND METHOD FOR ESTIMATING ENGINE OPERATING POINT OF A HYBRID VEHICLE

(75) Inventors: Sang Joon Kim, Seoul (KR); Joon Young Park, Seoul (KR)

(73) Assignee: HYUNDAI MOTOR COMPANY, Seoul (KR)

(21) Appl. No.: 13/033,827

(22) Filed: Feb. 24, 2011

(30) Foreign Application Priority Data
Dec. 1, 2010 (KR) 10-2010-0121187

(51) Int. Cl. B60W 20/00; B60W 10/08; B60W 10/06

(52) U.S. Cl. 477/3; 180/65.265; 903/902

(57) ABSTRACT

The present invention provides a system and method for estimating an engine operating point of a hybrid vehicle. The system includes an engine target speed conversion unit, a PI control unit, an anti wind-up feedback unit, and an engine torque compensation unit. The engine target speed conversion unit converts a target speed of the engine into a target speed of the first motor. The PI control unit calculates and orders a torque with respect to the first motor based on the target speed of the first motor. The anti wind-up feedback unit feeds back an anti wind-up term that is a torque shortage of the first motor to an engine torque compensation unit when the engine operating point is not changed into the target speed of the engine. The engine torque compensation unit compensates a calculated torque for an engine target torque to order the engine target torque. The engine torque compensation unit includes a torque conversion calculator for converting the anti wind-up term into a torque corresponding to an engine shaft.

### CROSS-REFERENCE TO RELATED APPLICATION

This application claims under 35 U.S.C. §119(a) the benefit of Korean Patent Application No. 10-2010-0121187 filed Dec. 1, 2010, the entire contents of which are incorporated herein by reference.

### BACKGROUND

(a) Technical Field

The present invention relates to a system and method for estimating an engine operating point of a vehicle, particularly a hybrid vehicle. More particularly, it relates to a system and method for estimating an engine operating point of a hybrid vehicle, which can improve performance of estimating the engine operating point in a situation where speed control performance on a motor is being reduced.

(b) Background Art

Generally, hybrid vehicles are future generation vehicles capable of reducing exhausting gases while also improving fuel efficiency, by adopting an engine and a motor driving source as an auxiliary power source.

An exemplary configuration of a power train for the power delivery of such a hybrid vehicle will be described below with reference to FIG. 1.

The power train of the hybrid vehicle of FIG. 1 includes an engine 10, a first motor MG1, a second motor MG2, and a pair of planetary gear sets 20 and 22. Also further shown is a shift control mode using the first motor MG1.

An output shaft of the engine 10 is connected to a carrier C1 of the first planetary gear set 20, and is further connected to the second sun gear S2 of the second planetary gear set 22 by means of a second clutch CL2.

An output shaft of the first motor MG1 is directly connected to a sun gear S1 of the first planetary gear set 20, while an output shaft of the second motor MG2 is directly connected to a second sun gear S2 of the second planetary gear set 22.

In this case, a ring gear R1 of the first planetary gear set 20 and a carrier C2 of the second planetary gear set 22 are connected to each other. As shown, the carrier C2 of the second planetary gear set 22 may further be connected to a final output shaft.

An output of the carrier C1 of the first planetary gear set 20 is connected to a ring gear R2 of the second planetary gear set 22 by means of a first clutch CL1.

A first brake BK1 is installed at a connection shaft between the first motor MG1 and the sun gear S1 of the first planetary gear set 20, and a second brake BK2 is installed at a connection shaft between the output of the carrier C1 of the first planetary gear set 20 and the ring gear R2 of the second planetary gear set 22.

This structure of the power train of the hybrid vehicle includes a shift control mode using the first motor MG1. Accordingly, the operating point of the engine is determined by the shift control of the first motor MG1. In other words, the operating point of the engine 10 is determined by the shift control of the first motor MG1 because the output shaft of the first motor MG1 is connected to the sun gear S1 of the first planetary gear set 20, while the output shaft of the engine is directly connected to the carrier C1 that is power-transferably connected by the sun gear S1 and a planetary gear (pinion).

However, in the power train system of the hybrid vehicle as described above, there are limitations in that the first motor MG1 is subject to power restriction, and estimation performance deteriorates when the operating point of the engine changes in a situation where a torque above a torque limit is necessary.

When the estimation performance regarding the engine operating point deteriorates, the vehicle cannot operate at its highest fuel efficiency at that current operation state. This may affect the fuel efficiency and State of Charge (SOC) balancing of a battery.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art.

In one aspect, the present invention provides a system for estimating an engine operating point of a hybrid vehicle including an engine (10), a first motor (MG1) for controlling engine cranking and engine speed, a second motor (MG2) as a traction motor for directly delivering a torque to an axle, a first planetary gear set (20) in connection between the engine and the first motor, and a second planetary gear set (22) in connection between the engine and the second motor, the system including: an engine target speed conversion unit (12) for converting a target speed of the engine (10) into a target speed of the first motor; a proportional-integral (PI) control unit (24) for calculating and ordering a torque with respect to the first motor based on the target speed of the first motor (MG1); an anti wind-up feedback unit (30) for feeding back an anti wind-up term that is a torque shortage of the first motor (MG1) to an engine torque compensation unit when the engine operating point is not changed into the target speed of the engine; the engine torque compensation unit (40) including a torque conversion calculator (42) for converting the anti wind-up term into a torque corresponding to an engine shaft; and the engine torque compensation unit (40) for compensating a calculated torque for an engine target torque to order it.

In another aspect, the present invention provides a method for estimating an engine operating point of a hybrid vehicle, comprising: calculating a target speed of a first motor (MG1) to determine the engine operating point based on an engine target speed; calculating an order torque with respect to the first motor (MG1) based on the target speed of the first motor; detecting if the engine operating point is not changed despite ordering/transmitting the order torque to the first motor; and compensating for an engine torque such that the engine operating point is changed into the target speed.

In a preferred embodiment, the step of detecting if the engine operating point is not changed may include detecting whether an anti wind-up term, which is a torque shortage of the first motor (MG1), equal to or similar to the engine operating point can be changed into the target speed.

In another preferred embodiment, the step of compensating for the engine torque may include: detecting the anti wind-up term to feed it back to an engine torque compensation unit (40); converting the anti wind-up term into a torque fit for an engine shaft; and compensating the torque fit for an engine target torque and ordering/transmitting the engine target torque to the engine.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram illustrating a configuration of a power train to which a system and method for estimating an engine operating point of a hybrid vehicle is applied according to an embodiment of the present invention;

FIG. 2 is a diagram illustrating a control configuration of a system for estimating an engine operating point of a hybrid vehicle according to an embodiment of the present invention; and

FIG. 3 is a flowchart illustrating a method for estimating an engine operating point of a hybrid vehicle according to an embodiment of the present invention.

Reference numerals set forth in the Drawings includes reference to the following elements as further discussed below:

| | |
|---|---|
| 10: engine | 12: engine target speed conversion |
| | unit |
| 20: first planetary gear set | 22: second planetary gear set |
| 24: PI control unit | 30: anti wind-up feedback unit |
| 40: engine torque compensation | 42: torque conversion calculation |
| unit | unit |
| MG1: first motor | MG2: second motor |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in detail with reference to the accompanying drawings.

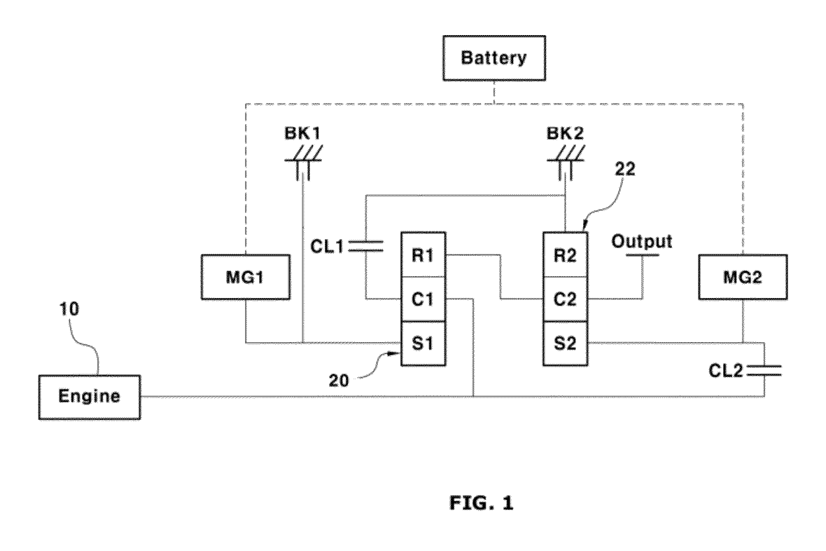

As described with reference to FIG. 1, a system and method for estimating an engine operating point of a hybrid vehicle according to an embodiment of the present invention may include an engine 10, a first motor MG1 for controlling engine cranking and engine speed, a second motor MG2 as a traction motor for directly delivering a torque to an axle, and a pair of planetary gear sets 20 and 22.

Particularly, the first motor MG1 may generate a reactive torque for delivering an engine torque to the axle, and may further perform a speed control for engine shifting in order to determine the engine operating point by performing shift control based on the target speed of the engine.

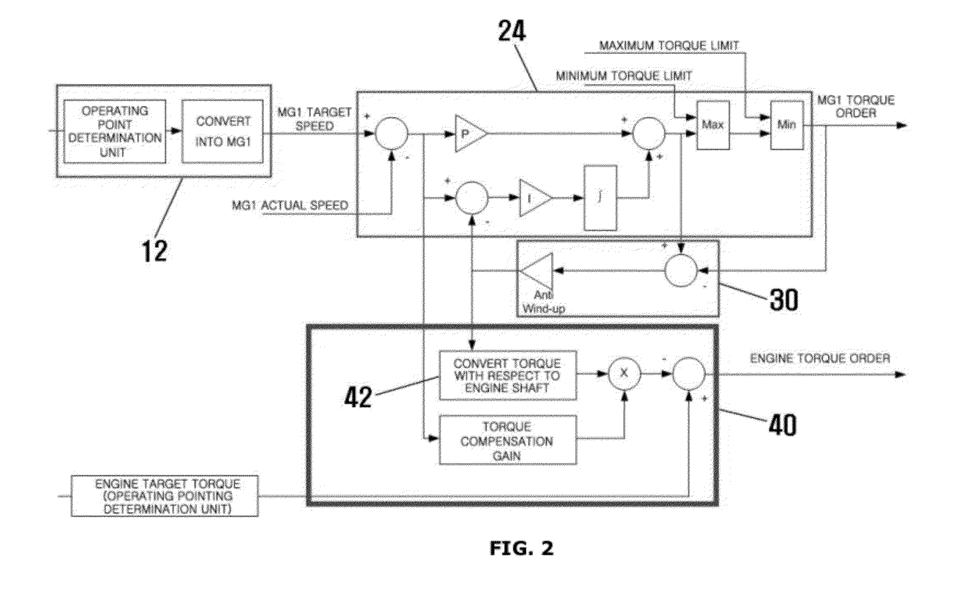

In order to provide a clear understanding of the present invention, an embodiment of a shift control process of the first motor MG1 will be described in detail with reference to FIG. 2.

Along with the cranking of the engine by the first motor MG1, if the target speed of the engine is inputted to a motor controller, since output shafts of the engine and the motor may have different shafts, the motor controller may convert the target speed of the engine into a value corresponding to a shaft of the first motor MG1, that is, the target speed of the first motor MG1.

Next, if the target speed of the first motor MG1 is inputted into a PI control unit 24, a torque matching the target speed of the first motor MG1 may be calculated through proportional integral operation logic. The calculated torque may then be ordered to the first motor MG1.

In this case, the torque of the first motor calculated in the PI control unit 24 may be defined within a minimum torque limit and a maximum torque limit to be outputted.

However, when the first motor MG1 is subject to a power restriction, or a torque above the torque limit is necessary (for example, when the target speed of the engine can be reached at a torque above the maximum torque limit of the first motor MG1), the estimation performance may be deteriorated upon a change of the engine operating point.

The present invention allows for the engine to reach the target speed quickly by compensating an engine torque in a situation where the engine operating point is difficult to change.

According to an embodiment of the present invention, a system for estimating an engine operating point of a hybrid vehicle may include an engine target speed conversion unit 10 for changing an engine target speed to a target speed of a first motor MG1; a PI control unit 24 for calculating and ordering a torque with respect to the first motor MG1 based on the target of the first motor MG1; an anti wind-up feedback unit 30 for feeding back an anti wind-up term to an engine torque compensating unit; and an engine toque compensating unit 40 for converting the anti wind-up term into a torque which corresponds to an engine shaft, and compensating for an engine target torque to order the torque to an engine.

According to embodiments of the invention, the engine torque compensating unit 40 may include a torque conversion calculation unit 42 for converting the anti wide-up term into a torque that corresponds to the engine shaft.

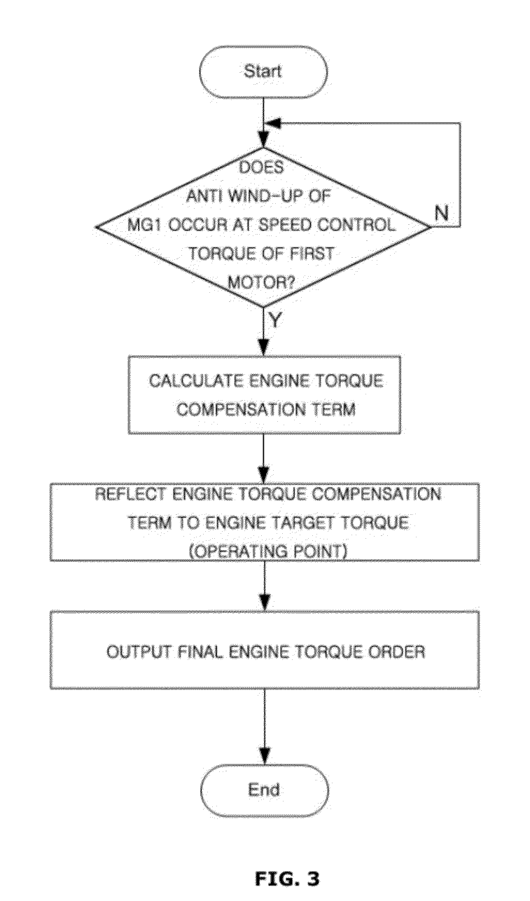

Hereinafter, a method for estimating an engine operating point of a hybrid vehicle according to an embodiment of the present invention, based on the above configuration, will be described in further detail with reference to FIGS. 2 and 3.

In a first step, if an engine target speed is inputted into an engine target speed conversion unit 12, a target speed of a first motor MG1 may be calculated so as to perform a speed control according to the engine target speed. In a next step, if the target speed of the first motor MG1 is inputted into a typical PI control unit 24, a torque may be calculated with respect to the first motor MG1 based on the target speed of the first motor MG1, and the calculated torque may be ordered to the first motor MG1. Thus, the first motor MG1 may be driven by the torque ordered to the first motor MG1, so that the engine operating point may be changed into the target speed.

In this case, a situation may occur where the first motor MG1 may be subject to power restriction, or it is difficult to change the operating point into the engine target speed despite the maximum torque of the first motor MG1, that is, an anti wind-up term may occur. When such a situation lasts for an extended period of time, charge/discharge balancing of a battery may break down, and it becomes difficult to manage State of Charge (SOC) of the battery, which may cause reduction of the fuel efficiency.

Hereupon, in order to compensate for an engine torque for quickly estimating the engine operating point, an anti wind-up feedback unit 30 may be provided to detect the anti wind-up term that can be expressed as a torque shortage of the first motor MG1. This torque shortage may be as much as the engine target speed which has been reached. The anti wind-up feedback unit 30 may feed the torque back to the engine torque compensation unit 40. For example, when the engine operating point is not changed into the target speed despite the torque calculated based on the target speed of the first motor MG1 and ordered to the first motor MG1, the anti wind-up feedback unit 30 may detect the anti wind-up term. This anti wind-up term may signify a torque that is as much as the engine can reach the target speed. The anti wind-up feedback unit 30 may further feed the anti wind-up term back to the engine torque compensation unit 40.

In a further step, a torque conversion calculator 42 of the engine torque compensation unit 40 may convert the anti wind-up term into a torque suitable for the engine shaft. That is, since output shafts of the engine and the motor have different shafts, the anti wind-up term may be converted into the torque suitable for the engine shaft.

In a next step, the engine torque compensation unit 40 may compensate the torque that is converted according to the engine shaft for the engine target torque, and then order/transmit it to the engine. As a result, the engine can quickly reach the target speed by the compensated torque.

According to an embodiment of the present invention, when a first motor performs a shift control for determining an engine operating point based on an engine target speed, and a power restriction or an anti wind-up term (i.e., a situation where the engine operating point is difficult to change) occurs despite the maximum torque, the anti wind-up term is fed back to a compensation unit to compensate for an engine target torque, thereby quickly changing the engine operating point into the target.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A system for estimating an engine operating point of a hybrid vehicle comprising an engine, a first motor for controlling engine cranking and engine speed, a second motor as a traction motor for directly delivering a torque to an axle, a first planetary gear set in connection between the engine and the first motor, and a second planetary gear set in connection between the engine and the second motor, the system comprising:
an engine target speed conversion unit for converting a target speed of the engine into a target speed of the first motor;
a PI control unit for calculating and ordering a torque with respect to the first motor based on the target speed of the first motor;
an anti wind-up feedback unit for feeding back an anti wind-up term that is a torque shortage of the first motor to an engine torque compensation unit when the engine operating point is not changed into the target speed of the engine;
the engine torque compensation unit comprising a torque conversion calculator for converting the anti wind-up term into a torque corresponding to an engine shaft; and
the engine torque compensation unit for compensating and ordering a calculated torque for an engine target torque.

2. A method for estimating an engine operating point of a hybrid vehicle, comprising:
calculating a target speed of a first motor (MG1) to determine the engine operating point based on an engine target speed;
calculating an order torque with respect to the first motor based on the target speed of the first motor;
detecting if the engine operating point is not changed despite the torque that is calculated based on the target speed of the first motor (MG1) is ordered to the first motor; and
when the engine operating point is not changed, compensating for an engine torque such that the engine operating point is changed into the target speed.

3. The method of claim 2, wherein the step of detecting if the engine operating point is not changed includes detecting an anti wind-up term that is a torque shortage of the first motor (MG1) as much as the engine operating point can be changed into the target speed.

4. The method of claim 2, wherein the step of compensating for the engine torque comprises:
detecting the anti wind-up term to feed back to an engine torque compensation unit (40);
converting the anti wind-up term into a torque for an engine shaft; and
compensating the torque for the engine shaft for an engine target torque, and ordering the engine target torque to the engine.
